(19) United States
(12) Patent Application Publication
(10) Pub. No.: US 2026/0367955 A1
(43) Pub. Date: Nov. 19, 2026

(54) CONTAINER STATUS MANAGEMENT IN DISTRIBUTED ENVIRONMENTS

(71) Applicant: Boost SubscriberCo L.L.C., Englewood, CO (US)

(72) Inventors: Ankesh Arora, Bangalore (IN); Kenneth William Weber, JR., Littleton, CO (US)

(21) Appl. No.: 19/207,891

(22) Filed: May 14, 2025

(51) Int. Cl. G06F 9/455; G06F 11/30

(52) U.S. Cl. CPC G06F 9/45558; G06F 11/3055; G06F 2009/4557; G06F 2009/45591

(57) ABSTRACT

A disclosed method may include (i) receiving, by a wrapper application, status information retrieved by a container orchestration command executed in a distributed container management environment that interfaces with a third-party cloud computing platform, the status information comprising data for a plurality of containers in a cluster that is part of the distributed container management environment and that is allocated to a subscriber of the third-party cloud computing platform and (ii) applying, by the wrapper application to the received status information, identification criteria comprising at least two of: (a) a non-ready state, (b) a non-running status, or (c) a restart within a specified time period to identify containers that satisfy the identification criteria such that the wrapper application checks for whether any of the at least two criteria applies to each respective container in the cluster. .

### BRIEF SUMMARY

This disclosure is generally directed to systems, methods, and computer-readable media relating to container status management in distributed environments. Distributed container management environments have become increasingly prevalent in modern computing infrastructures. These environments may facilitate the deployment, scaling, and management of containerized applications across multiple hosts or nodes. As the complexity and scale of these environments grow, so too may the challenges associated with monitoring and maintaining the health and status of individual containers within the system. Administrators and developers may find themselves overwhelmed by the sheer volume of information generated by container orchestration platforms, making it difficult to quickly identify and address issues that may arise within the containerized ecosystem.

One of the primary challenges in managing large-scale container environments may be the efficient identification of problematic containers among potentially hundreds or thousands of instances. Traditional container orchestration commands may provide comprehensive status information for all containers within a cluster, but this raw data may be overwhelming and time-consuming to parse manually. Administrators may need to sift through extensive logs or output to pinpoint specific containers that may be experiencing issues, such as being in a non-ready state, having a non-running status, or undergoing frequent restarts. This process may be particularly cumbersome when dealing with clusters that span multiple availability zones or regions, as the volume of data to analyze may increase exponentially with the scale of the infrastructure.

A technique for addressing this challenge may involve the development of a wrapper application that extends the functionality of existing container orchestration commands. This wrapper may act as an intermediary layer between the user and the underlying container management system, processing the raw status information and applying sophisticated filtering techniques to identify containers that meet specific criteria indicative of potential issues. By automating the analysis of container status data, this technique may significantly reduce the time and effort required for administrators to isolate problematic instances within their environment.

The wrapper application may be designed to interface with third-party cloud computing platforms, allowing it to retrieve status information for containers allocated to subscribers of these services. This integration may enable the technique to be applied across a wide range of cloud environments, providing flexibility and adaptability for organizations utilizing different infrastructure providers. The wrapper may execute container orchestration commands with additional parameters, such as region specifications or time period constraints, to further refine the scope of the analysis and tailor the output to the specific needs of the user.

Another challenge in container management may be the rapid identification of faulty nodes across multiple availability zones within a cluster. In large-scale deployments, issues affecting individual nodes may have cascading effects on the overall system performance, making swift detection and resolution of these problems highly beneficial. Related monitoring techniques may struggle to provide a comprehensive view of node health across geographically distributed clusters, potentially leading to delays in identifying and addressing critical issues.

In some examples, the proposed technique may address this challenge by incorporating functionality within the wrapper application to process and analyze node status information across multiple availability zones simultaneously. By applying sophisticated filtering and/or aggregation algorithms, the wrapper may quickly identify patterns or anomalies that may indicate faulty nodes, even when these nodes are distributed across different regions or data centers. This capability may enable administrators to proactively address potential issues before they escalate, helping to maintain the overall stability and performance of the containerized environment.

The volume of container status data generated in large-scale environments may present another significant challenge for effective management. As the number of containers in a cluster grows into the hundreds or thousands, the amount of status information that needs to be processed and analyzed may become overwhelming. Traditional methods of manually reviewing this data may become impractical, potentially leading to overlooked issues or delayed responses to certain problems within the containerized ecosystem.

To address this challenge, the wrapper application may be designed to efficiently process large volumes of container status data, leveraging optimized algorithms and data structures to quickly identify problematic containers from among hundreds or thousands of instances. By automating this analysis process, the technique may enable administrators to gain insights into the health of their container environment more rapidly and with greater accuracy than manual methods. This capability may be particularly beneficial in scenarios where real-time monitoring and quick response times are more important, such as in production environments or mission-critical systems.

The presentation of filtered and analyzed data in a clear and actionable format may be another key aspect of effective container management. Raw status information, even when properly filtered, may still be difficult for users to interpret quickly and accurately. This challenge may be compounded in scenarios where multiple team members with varying levels of expertise need to collaborate on resolving issues within the containerized environment.

The proposed technique may address this challenge by incorporating advanced formatting and/or visualization capabilities within the wrapper application. The filtered output generated by the wrapper may be presented in a tabular form or other easily readable formats, enhancing the user's ability to quickly comprehend the status of problematic containers. This formatted output may include relevant details such as container identifiers, current states, and/or historical data on restarts or other issues, providing a comprehensive yet concise overview of the container environment's health. By improving the readability and accessibility of this critical information, the technique may facilitate faster decision-making and more effective collaboration among team members responsible for maintaining the containerized infrastructure.

In some examples, a method includes (i) receiving, by a wrapper application, status information retrieved by a container orchestration command executed in a distributed container management environment that interfaces with a third-party cloud computing platform, the status information comprising data for a plurality of containers in a cluster that is part of the distributed container management environment and that is allocated to a subscriber of the third-party cloud computing platform, (ii) applying, by the wrapper application to the received status information, identification criteria comprising at least two of: (a) a non-ready state, (b) a non-running status, or (c) a restart within a specified time period to identify containers that satisfy the identification criteria such that the wrapper application checks for whether any of the at least two criteria applies to each respective container in the cluster, and (iii) generating, by the wrapper application, a filtered output that comprises status details for the identified containers while filtering out at least one container that does not meet the identification criteria such that the filtered output presents a subset of the received status information to reduce a burden on a user of identifying the filtered output from within the received status information.

In some examples, the identification criteria comprise (i) the non-ready state and (ii) the non-running status.

In some examples, the identification criteria comprise (i) the non-ready state and (iii) the restart within the specified time period.

In some examples, the identification criteria comprise (ii) the non-running status and (iii) the restart within the specified time period.

In some examples, the identification criteria comprise (i) the non-ready state, (ii) the non-running status, and (iii) the restart within the specified time period.

In some examples, the third-party cloud computing platform comprises a publicly available cloud computing service.

In some examples, the method further comprises executing the container orchestration command with at least one additional parameter that comprises one or more of: a help request, a region specification, a time period specification for a restart criterion, a result type specification, or a container exclusion specification.

In some examples, the method further comprises formatting the filtered output into a tabular form to enhance readability for the user.

In some examples, the wrapper application comprises a script that extends functionality of the container orchestration command.

In some examples, the distributed container management environment comprises a Kubernetes-compatible system.

In some examples, the container orchestration command comprises a command that retrieves status information for all containers in a specified cluster.

In some examples, the container orchestration command comprises kubectl.

In some examples, the specified time period is configurable by the user.

In some examples, the method further comprises storing the filtered output in a log file for subsequent analysis.

In some examples, the wrapper application processes a volume of container status data such that problematic containers are identified from a search of at least a hundred containers in the cluster.

In some examples, the wrapper application increases a speed with which faulty nodes are identified across multiple availability zones in the cluster.

In some examples, a non-transitory computer-readable medium has instructions stored thereon that, when executed by at least one physical computing processor, cause a computing device to perform operations comprising (i) receiving, by a wrapper application, status information retrieved by a container orchestration command executed in a distributed container management environment that interfaces with a third-party cloud computing platform, the status information comprising data for a plurality of containers in a cluster that is part of the distributed container management environment and that is allocated to a subscriber of the third-party cloud computing platform, (ii) applying, by the wrapper application to the received status information, identification criteria comprising at least two of: (a) a non-ready state, (b) a non-running status, or (c) a restart within a specified time period to identify containers that satisfy the identification criteria such that the wrapper application checks for whether any of the at least two criteria applies to each respective container in the cluster, and (iii) generating, by the wrapper application, a filtered output that comprises status details for the identified containers while filtering out at least one container that does not meet the identification criteria such that the filtered output presents a subset of the received status information to reduce a burden on a user of identifying the filtered output from within the received status information.

In some examples, a system comprises at least one physical computing processor of a computing device and a non-transitory computer-readable medium that has instructions stored thereon that, when executed by the at least one physical computing processor, cause the computing device to perform operations comprising (i) receiving, by a wrapper application, status information retrieved by a container orchestration command executed in a distributed container management environment that interfaces with a third-party cloud computing platform, the status information comprising data for a plurality of containers in a cluster that is part of the distributed container management environment and that is allocated to a subscriber of the third-party cloud computing platform, (ii) applying, by the wrapper application to the received status information, identification criteria comprising at least two of: (a) a non-ready state, (b) a non-running status, or (c) a restart within a specified time period to identify containers that satisfy the identification criteria such that the wrapper application checks for whether any of the at least two criteria applies to each respective container in the cluster, and (iii) generating, by the wrapper application, a filtered output that comprises status details for the identified containers while filtering out at least one container that does not meet the identification criteria such that the filtered output presents a subset of the received status information to reduce a burden on a user of identifying the filtered output from within the received status information.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to container status management in distributed environments.

FIG. 2 illustrates an example of unfiltered container status output from a container orchestration command, which demonstrates the volume and complexity of raw data that may be generated in a distributed container management environment.

FIG. 3 depicts a conceptual diagram representing the challenge faced by a user attempting to locate specific container status information within a large volume of unprocessed output data.

FIG. 4 presents an example of partially processed container status output, which showcases the results of initial filtering techniques applied to the raw data, but prior to formatting enhancements.

FIG. 5 displays an example of processed and formatted container status output, which illustrates the presentation of filtered data in a tabular format with additional stylistic elements to enhance readability.

FIG. 6 shows an example of a command-line interface that may be used to interact with a wrapper application, including various optional parameters that may be specified by the user to customize the filtering and output of container status information.

FIG. 7 illustrates a flow diagram representing a process for identifying containers that may be experiencing issues based on multiple criteria such as readiness state, running status, and restart frequency.

FIG. 8 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

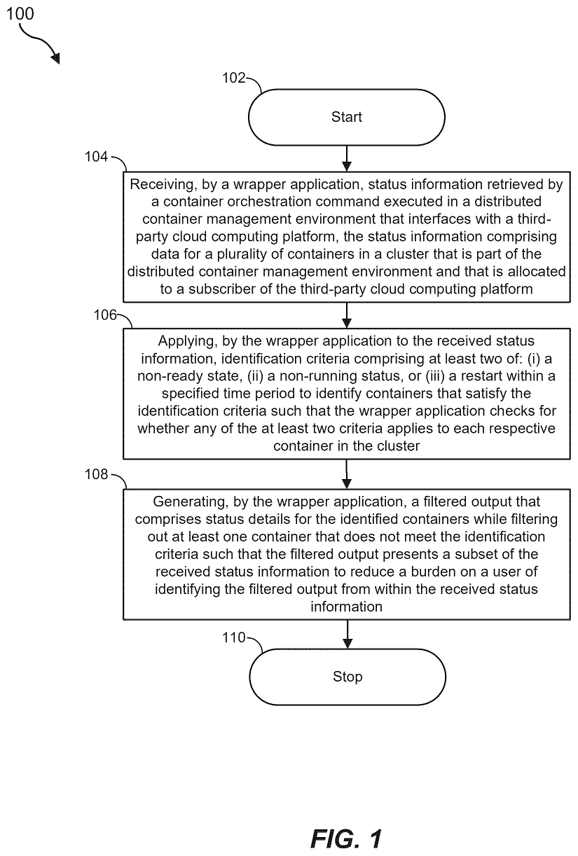

FIG. 1 shows a flow diagram for a method 100 relating to container status management in distributed environments. The method 100 may begin at step 102 and proceed to step 104, where a wrapper application may receive status information retrieved by a container orchestration command. This command may be executed in a distributed container management environment that interfaces with a third-party cloud computing platform. The status information may comprise data for a plurality of containers in a cluster that is part of the distributed container management environment and that may be allocated to a subscriber of the third-party cloud computing platform. In step 106, the wrapper application may apply identification criteria to the received status information. These criteria may comprise at least two of: (i) a non-ready state, (ii) a non-running status, or (iii) a restart within a specified time period. The wrapper application may identify containers that satisfy the identification criteria by checking whether any of the at least two criteria applies to each respective container in the cluster. In step 108, the wrapper application may generate a filtered output that comprises status details for the identified containers. This step may involve filtering out at least one container that does not meet the identification criteria, such that the filtered output presents a subset of the received status information. This filtered output may reduce the burden on a user of identifying relevant information from within the larger set of received status information. The method 100 may then end at step 110. As used herein, a wrapper application may refer to an application that extends the functionality of a distributed container management environment command such as kubectl, as discussed further below.

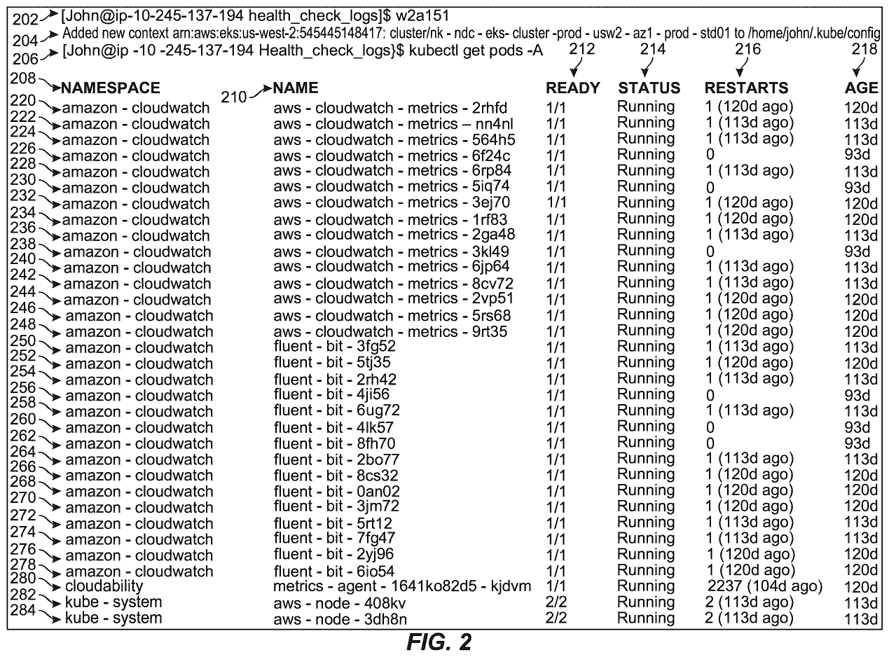

FIG. 2 shows an example of unfiltered container status output that may be generated by a container orchestration command in a distributed container management environment. The figure illustrates the volume and/or complexity of raw data that may be produced when querying the status of multiple containers across a cluster. This type of output may present challenges for administrators or users who may seek to quickly identify problematic containers or assess the overall health of the container ecosystem. The sheer quantity of information presented may make it difficult to manually review and/or check for potential issues, especially in large-scale deployments where the number of containers may be significantly higher than shown in this example. In some scenarios, the time required to manually parse such extensive output may delay interventions or impede efficient management of the container infrastructure.

The output may include metadata 202-206, which provide context for the command execution. For instance, the metadata may show the user and/or system from which the command was run, as well as any additional context or parameters used in the execution. In this example, the first line 202 may indicate the user and/or system, the second line 204 may show additional context related to the AWS EKS cluster, and/or the third line 206 may display the specific kubectl command used to retrieve the pod information. This metadata may be helpful for auditing purposes or for reproducing the query in different environments, but it may also contribute to the overall volume of information that needs to be processed by the user.

The output may be organized into columns, each representing different aspects of container status. In this example, the columns may include NAMESPACE 208, NAME 210, READY 212, STATUS 214, RESTARTS 216, and/or AGE 218. These columns may provide a structured view of the container information, but the sheer quantity of data may make it challenging for a user to quickly identify any problematic containers. The NAMESPACE column 208 may indicate the Kubernetes namespace to which each pod belongs, while the NAME column 210 may provide the unique identifier for each pod. The READY column 212 may show the number of ready containers compared to the total number of containers in the pod, the STATUS column 214 may indicate the current operational state of the pod, the RESTARTS column 216 may show how many times the pod has been restarted, and/or the AGE column 218 may indicate how long the pod has been running. While this structured format may be designed to present information clearly, the volume of data may still overwhelm users attempting to quickly assess the health of their container environment.

Rows 220-284 represent individual containers and/or their respective status information. In this example, all containers shown may be in a ready state (e.g., “1/1” or “2/2” in the READY column 212) and/or may have a “Running” status in the STATUS column 214. The RESTARTS column 216 may show various counts of restarts for different containers, while the AGE column 218 may indicate how long each container has been in its current state. For instance, row 220 may show a pod in the amazon-cloudwatch namespace with one restart 120 days ago, while row 284 may show a pod in the kube-system namespace with two restarts 113 days ago. This detailed information for each container may be valuable for in-depth analysis, but it may also contribute to information overload when trying to quickly identify problematic containers across a large cluster.

While this output may provide comprehensive information about the container ecosystem, the volume of data may make it difficult for an administrator to manually review and/or identify potential issues. For instance, even though all containers in this example may appear to be running correctly, a high number of restarts or other subtle indicators of problems may be easily overlooked in such a large dataset. This challenge may be particularly pronounced in larger deployments where the number of containers may be significantly higher, potentially spanning hundreds or thousands of entries. The difficulty in manually parsing this type of output may underscore the potential benefits of automated filtering and/or analysis techniques, which may help administrators more efficiently identify containers that may require attention, even when the raw output may not immediately reveal obvious issues. Such techniques may help reduce the cognitive load on administrators and/or enable faster response times to potential container health issues, ultimately contributing to more robust and/or reliable container-based infrastructures.

In some examples, the identification criteria may comprise the non-ready state and the non-running status. The concept of identification criteria in container orchestration environments may encompass a wide range of parameters and conditions that may be used to assess the health, performance, and/or operational status of containers within a cluster. While the non-ready state and non-running status may serve as indicators of potential issues, the identification criteria may be expanded to include various other metrics and thresholds that may provide a more comprehensive view of container health. For instance, the criteria may include resource utilization metrics such as CPU usage, memory consumption, and/or network throughput, which may help identify containers that may be experiencing performance bottlenecks or resource constraints. Additionally, the identification criteria may incorporate application-specific health checks that may be tailored to the particular requirements of the services running within the containers. These checks may include custom probes that verify the availability of endpoints, database connectivity, or the proper functioning of key application components. In some implementations, the identification criteria may also consider historical data and trends, allowing for the detection of gradual degradation in container performance or recurring patterns of instability. The wrapper application may be designed to support dynamic and configurable identification criteria, enabling administrators to adjust the sensitivity and focus of the container health assessment based on the specific needs of their environment. This flexibility may allow for the creation of multi-tiered monitoring schemes, where different sets of criteria may be applied to various container groups or application tiers. Furthermore, the identification criteria may be extended to include contextual information from the broader infrastructure, such as the status of underlying host systems, network conditions, or even external dependencies. By incorporating this wider context, the wrapper application may provide a more nuanced and accurate assessment of container health, potentially reducing false positives and enabling more targeted troubleshooting efforts. As illustrated in FIG. 2, the raw output from container orchestration commands may contain a wealth of information that may be leveraged to construct sophisticated identification criteria. The columns for READY 212 and STATUS 214 may serve as starting points for assessing container health, but the wrapper application may go beyond these basic indicators to extract and analyze additional data points that may be present in the output. This may include parsing the RESTARTS 216 and AGE 218 columns to identify patterns or anomalies that may not be immediately apparent from the ready state or running status alone.

In some examples, the identification criteria may comprise a restart within a specified time period, in addition to the non-ready state and non-running status checks. This restart criterion may be a valuable indicator of container stability and reliability, potentially highlighting instances where containers are experiencing frequent crashes or unexpected terminations. The specified time period for restart checks may be configurable, allowing administrators to adjust the sensitivity of this criterion based on their specific operational requirements or the expected behavior of different types of containers. For instance, a shorter time window may be used for more critical services where any restart is considered anomalous, while a longer window may be more appropriate for services with expected occasional restarts. Beyond simple restart counting, the criteria may incorporate more sophisticated restart-related checks, such as analyzing patterns in restart frequency, correlating restarts with specific events or time periods, or examining the duration between restarts. These advanced restart criteria may help identify subtle issues like memory leaks, resource contention, or configuration problems that may manifest as periodic restarts rather than complete failures. Additionally, the identification criteria may extend far beyond these three basic checks, encompassing a wide array of sophisticated metrics and custom-defined conditions. These advanced criteria may leverage complex business logic, algebraic formulas, and multi-faceted evaluations to provide a more nuanced and comprehensive assessment of container health and performance. Administrators may have the flexibility to create their own custom formulas and checks, tailoring the identification process to the specific needs and characteristics of their container environments. For instance, a custom check may combine multiple metrics using boolean algebra, such as flagging containers that exhibit high CPU utilization AND abnormal memory growth OR unexpected network traffic patterns. These compound conditions may help identify subtle issues that may not be apparent from individual metric thresholds alone. The criteria may also incorporate time-based analyses, allowing for the detection of trending issues or cyclical patterns. For example, a check may flag containers that show a consistent increase in response time over a specified period, even if individual measurements remain below a critical threshold. Similarly, containers that exhibit regular spikes in resource usage aligned with specific time intervals may be identified for further investigation. Advanced statistical techniques, such as moving averages, standard deviation calculations, or more complex anomaly detection algorithms, may be employed to establish dynamic baselines and identify containers that deviate significantly from expected behavior.

In some examples, the wrapper application may process a volume of container status data such that problematic containers are identified from a search of at least a hundred containers in the cluster. This capability may be particularly valuable in large-scale distributed container management environments where manual inspection of individual container statuses may be impractical or time-consuming. The wrapper application may employ various techniques to efficiently process and analyze the substantial volume of data generated by container orchestration commands, as illustrated in FIG. 2. For instance, the application may utilize parallel processing algorithms to simultaneously evaluate multiple containers' statuses, potentially leveraging multi-threaded or distributed computing architectures to scale its processing capabilities. The wrapper application may implement sophisticated indexing and search algorithms to rapidly traverse the large dataset represented by the numerous rows in FIG. 2, each corresponding to a different container. These algorithms may be designed to efficiently identify patterns or anomalies across the various columns, such as READY 212, STATUS 214, and RESTARTS 216, even when dealing with hundreds or thousands of entries. Additionally, the application may employ data compression techniques to manage the memory footprint of large datasets, allowing for efficient in-memory processing of status information from vast numbers of containers. The wrapper may also implement incremental processing strategies, continuously updating its analysis as new data becomes available rather than reprocessing the entire dataset for each query. This approach may be particularly beneficial in dynamic environments where container states may change rapidly, allowing for near real-time identification of problematic containers even in very large clusters. Furthermore, the application may leverage statistical sampling techniques to quickly estimate the overall health of the cluster and identify potential hotspots or areas of concern, before conducting more detailed analysis on specific subsets of containers. The wrapper may also employ adaptive thresholding algorithms that automatically adjust the criteria for identifying problematic containers based on the overall characteristics of the cluster, ensuring that the search remains effective and relevant even as the scale of the deployment grows from hundreds to thousands or tens of thousands of containers. By combining these various techniques, the wrapper application may be capable of efficiently processing and analyzing status data for large numbers of containers, potentially identifying subtle issues or emerging problems that might otherwise go unnoticed in large-scale deployments.

In some examples, the wrapper application may be implemented as a Python script that processes the output from a kubectl command in a Kubernetes environment. However, this technique may be applicable across a wide range of container orchestration systems and programming languages. At a higher level of abstraction, the one inventive concept involves a supplementary application that enhances the functionality of existing container management tools by processing and/or analyzing their output to provide more targeted and/or actionable information. This wrapper application may be implemented in various programming languages beyond Python, such as Java, Go, Ruby, and/or JavaScript, each offering different performance characteristics and/or integration capabilities with container orchestration platforms. The choice of language may depend on factors such as the existing technology stack, performance requirements, and/or developer expertise.

Moving down a layer of abstraction, the wrapper application may interact with different container orchestration systems beyond Kubernetes. For instance, it may be adapted to work with Docker Swarm, Apache Mesos, and/or OpenShift, each with their own command-line interfaces and/or output formats. In a Docker Swarm environment, the wrapper may process output from commands like ‘docker service ls’ and/or ‘docker node ls’. For Mesos, it might analyze data from the Mesos HTTP API and/or Marathon API. In OpenShift, the wrapper could work with the ‘oc’ command-line tool, which is similar to kubectl but with additional OpenShift-specific features. The wrapper application may also be designed to work with cloud-specific container orchestration services, such as Amazon ECS (Elastic Container Service) and/or Google Cloud Run, potentially processing output from their respective CLI tools and/or API responses. At a lower level of abstraction, the implementation may vary in how it interacts with the container orchestration system. Instead of relying on command-line output, the wrapper may directly interface with the orchestration system's API. For Kubernetes, this could involve using a client library like the official Kubernetes Python client to query the API server directly. Similar approaches could be taken for other orchestration systems, using their respective API clients and/or SDKs. This direct API interaction may offer more flexibility and/or potentially better performance, especially when dealing with large-scale deployments. The wrapper application may also be implemented as a standalone service rather than a script. In this scenario, it might run continuously, periodically querying the container orchestration system for updates and/or maintaining its own state. This approach could enable real-time monitoring and/or alerting capabilities. Alternatively, the wrapper could be implemented as a serverless function, triggered by events and/or scheduled intervals to perform its analysis. Regarding the execution model, the wrapper may indeed execute the container orchestration commands itself, providing a self-contained solution. This approach may offer more control over the execution environment and/or parameters. Conversely, the wrapper may be designed to operate on pre-existing output, perhaps reading from log files and/or consuming messages from a queue where container status information is already being collected. This decoupled approach may be beneficial in environments where direct access to the container orchestration system is restricted and/or where the wrapper needs to process historical data.

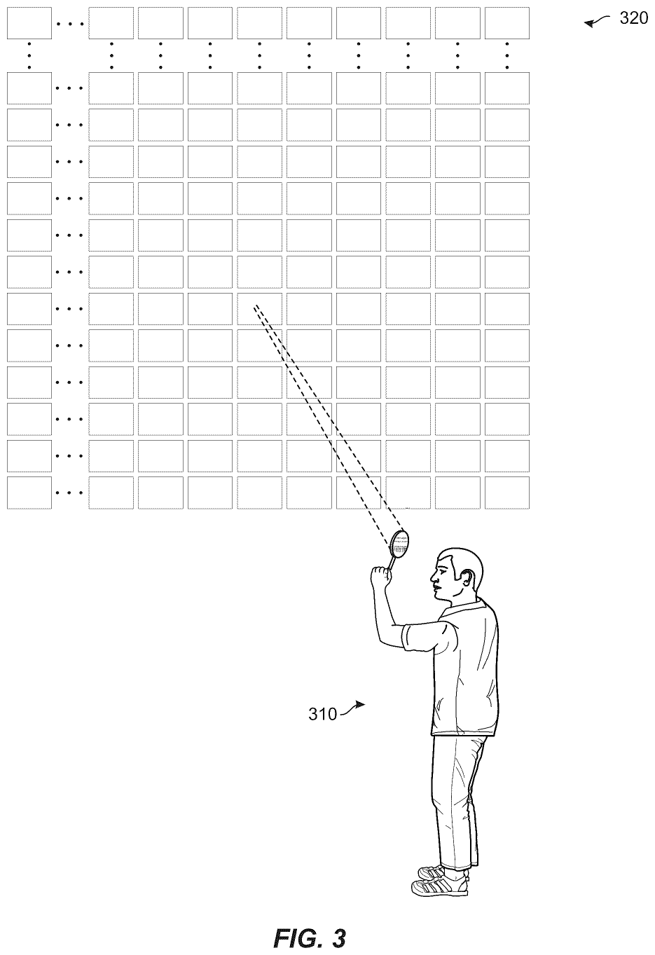

FIG. 3 shows an example conceptual diagram illustrating the challenge of manually reviewing container status information in a distributed container management environment. The figure depicts a human user 310 examining an array of data representations 320, each of which may correspond to an output similar to that shown in FIG. 2. This visual metaphor may underscore the difficulty faced by administrators or operators when attempting to identify problematic containers or assess the overall health of a container ecosystem, especially in large-scale deployments where the volume of data may be overwhelming.

The human user 310 is shown holding a magnifying glass, which may symbolize the intense scrutiny and/or attention to detail that may be required when manually parsing through extensive container status outputs. This representation may highlight the time-consuming and potentially error-prone nature of manual review processes, particularly when dealing with clusters that may contain hundreds or thousands of containers. The array of data representations 320 may illustrate the sheer quantity of information that an administrator may seek to process, with each square potentially representing a separate output for different clusters, namespaces, or time periods. The repetitive nature of these data blocks may further emphasize the cognitive load placed on the user, as they may seek to maintain focus and/or attention to detail across numerous similar-looking datasets. In some scenarios, this manual review process may lead to oversight of subtle issues or delays in identifying critical problems, potentially impacting the overall stability and/or performance of the container environment. The visual metaphor presented in FIG. 3 may underscore the potential benefits of automated filtering and/or analysis techniques, which may help alleviate the burden on human operators and/or enable more efficient management of large-scale container deployments.

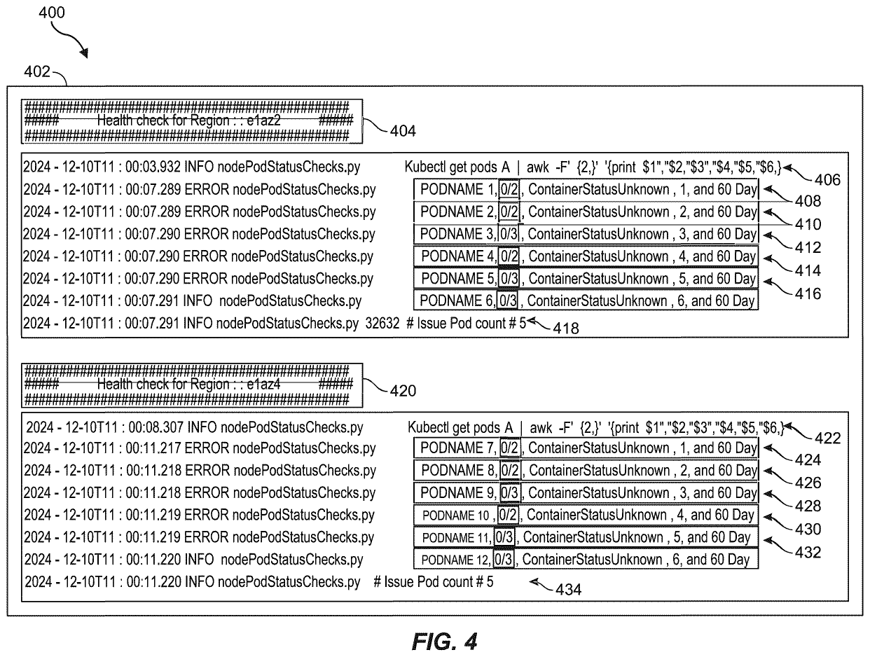

FIG. 4 shows an example of partially processed container status output 400 that may be generated by a wrapper application in a distributed container management environment. The figure illustrates the initial filtering and/or formatting that may be applied to raw container status data, presenting a more focused view of potentially problematic containers. This output 400 may represent an intermediate step between the raw data shown in FIG. 2 and/or the processed and/or formatted output that may be presented to an administrator or user. The segmentation of the output into distinct regions may allow for a more granular analysis of container health across different parts of the infrastructure, which may be particularly helpful in large-scale deployments where issues may be localized to specific availability zones or clusters. Additionally, this intermediate format may serve as a foundation for further processing or visualization techniques that may enhance the ability of administrators to quickly identify and/or address potential issues within their container ecosystem.

The output 400 may be divided into sections corresponding to different regions or availability zones within the distributed container management environment. In this example, the top section 402 may show results for a region identified as “e1az2,” while the bottom section 420 may display results for a region labeled “e1az4.” This segmentation may allow administrators to quickly assess the status of containers across different parts of their infrastructure, potentially identifying location-specific issues or patterns. Each section may begin with a header that identifies the region and/or provides additional context. For instance, the header in section 402 may include text indicating that it is a “Health check for Region :: e1az2.” Similarly, the header in section 420 may specify that it is a “Health check for Region :: e1az4.” These headers may help users quickly navigate through the output, especially when dealing with multiple regions or zones. The organization of data by region may also facilitate comparative analysis between different parts of the infrastructure, potentially revealing trends or anomalies that may not be apparent when examining container status data in aggregate. This regional breakdown may be particularly valuable in scenarios where container performance or health may be influenced by factors specific to certain geographical areas or data centers.

Following the headers, each section may include a row (406 for the top section and/or 422 for the bottom section) that displays the specific container orchestration command used to retrieve the status information. This may include any parameters or flags that were applied to the command. For example, row 406 may show a command like “kubectl get pods −A|awk −F′ {2,}′ ‘{print $1”, “$2, “$3”, “$4, “$5, “$6,}’”, which indicates that the wrapper application is using a combination of container orchestration commands and/or text processing tools to extract and/or format the relevant information. The inclusion of these command details may serve multiple purposes: it may provide transparency into the data collection process, allow for reproducibility of results, and/or offer insights into how the wrapper application is interacting with the underlying container orchestration system. This information may be particularly valuable for troubleshooting or refining the filtering process, as administrators may use these command details to understand the scope of the data being analyzed and/or to modify the criteria for identifying problematic containers.

The subsequent rows in each section (408-416 for the top section and/or 424-434 for the bottom section) may display information about individual containers that have been flagged as potentially problematic based on certain criteria. Each row may represent a different container, identified by a unique PODNAME (e.g., PODNAME 1, PODNAME 2, etc.). The information presented for each container may include details such as its readiness state, current status, restart count, and/or age. For instance, rows 408-416 in the top section may show information for PODNAME 1 through PODNAME 6, while rows 424-432 in the bottom section may display data for PODNAME 7 through PODNAME 12. Each of these entries may provide specific details about the container's state, such as “ContainerStatusUnknown” for the status and/or various restart counts and/or ages. This focused presentation of potentially problematic containers may significantly reduce the cognitive load on administrators by eliminating the need to sift through data for containers that are operating within expected parameters. The consistency in the format of this information across different containers and/or regions may also facilitate quicker identification of patterns or anomalies that may warrant further investigation.

At the end of each section, there may be a summary row (e.g., row 418 for the top section and/or row 434 for the bottom section) that provides an aggregate count of the issue pods identified in that region. This summary may offer a quick overview of the number of containers that may require attention in each availability zone. The inclusion of these summary statistics may provide a high-level view of container health across different regions, allowing administrators to quickly gauge the overall state of their infrastructure and/or prioritize their efforts based on the areas with the highest concentration of potential issues. The combination of detailed container-specific information and/or region-level summaries may offer a multi-faceted view of the container ecosystem, supporting both granular analysis and/or broader trend identification.

In some examples, the container orchestration command may comprise a command that retrieves status information for all containers in a specified cluster. This command may be implemented in various ways across different container orchestration platforms, extending beyond the specific kubectl command shown in FIG. 4. The command may be designed to provide comprehensive status information for containers within a defined scope, which may range from a single cluster to multiple clusters across different regions or availability zones. In some implementations, the command may support filtering options to narrow down the scope of containers for which status information is retrieved, potentially based on namespaces, labels, or other metadata. The retrieved status information may include a wide array of data points, such as the readiness state, current operational status, restart count, and age of each container, as illustrated in the output rows 408-416 and 424-434 of FIG. 4. Additionally, the command may be capable of retrieving more detailed information, such as resource utilization metrics, log snippets, or configuration details, depending on the specific container orchestration platform and its capabilities. The command may be executed through various interfaces, including command-line tools, API calls, or graphical user interfaces, providing flexibility in how it is integrated into different operational workflows. In some scenarios, the command may support output formatting options, allowing the status information to be returned in formats such as JSON, YAML, or tabular text, which may facilitate easier parsing and processing by the wrapper application. The command may also offer options for specifying the level of detail in the retrieved information, potentially allowing for quick summary views or more in-depth diagnostics. Furthermore, the command may be designed to handle large-scale environments efficiently, potentially employing techniques such as pagination or streaming to manage the retrieval of status information for thousands of containers without overwhelming system resources. The implementation of the command may vary depending on the underlying architecture of the container orchestration platform, potentially leveraging distributed query mechanisms or caching strategies to improve performance in large clusters. In some cases, the command may be extended or customized to include platform-specific or organization-specific status checks, allowing for a more tailored view of container health based on specific operational requirements or service level agreements.

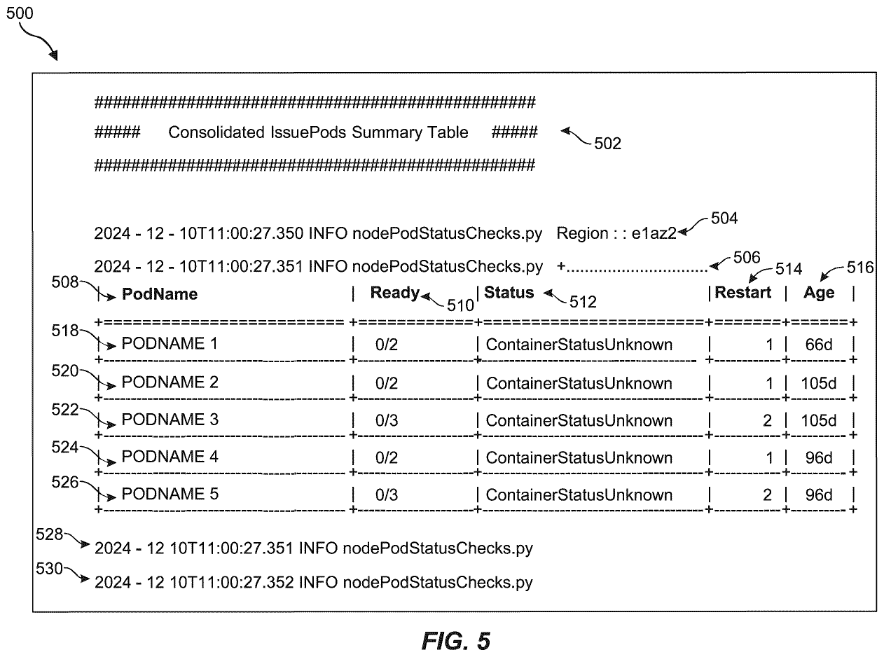

FIG. 5 shows an example of a more fully processed and/or formatted container status output 500 that may be generated by a wrapper application in a distributed container management environment. This figure illustrates a more refined presentation of the container status information, which may be designed to enhance readability and/or facilitate quicker identification of problematic containers. The output may be structured in a tabular format, which may allow for easier visual parsing of the data compared to the raw or partially processed outputs shown in previous figures. This type of presentation may be particularly helpful in scenarios where administrators may seek to quickly assess the health of their container ecosystem and/or identify specific containers that may require attention. The consolidation and/or formatting of the data in this manner may represent a significant improvement in the efficiency of container management processes, potentially reducing the time and/or effort used to identify and/or address issues within large-scale container deployments. Additionally, this structured format may lend itself well to further automated analysis or integration with other management tools, potentially enabling more sophisticated monitoring and/or alerting systems that may enhance the overall reliability and/or performance of the container infrastructure.

The figure includes a header 504 that reads “Consolidated Issue Pods Summary Table,” which may indicate that this output represents a focused view of containers that have been flagged as potentially problematic based on certain criteria. This consolidation may significantly reduce the volume of information that an administrator may seek to review, potentially streamlining the process of identifying and/or addressing issues within the container environment. The use of a summary table format may also facilitate easier comparison between different containers and/or quick identification of patterns or trends across the problematic pods. Below the header, there may be metadata information, such as line 506, which specifies the region or availability zone (in this case, “e1az2”) to which the displayed data pertains. This regional context may be helpful for administrators managing large-scale, geographically distributed container environments, as it may allow them to quickly identify whether issues are localized to specific areas of their infrastructure or if they are more widespread. The inclusion of this metadata may also support more targeted troubleshooting efforts and/or resource allocation decisions based on the distribution of problematic containers across different regions or zones. Furthermore, the combination of a clear header and/or relevant metadata may provide a comprehensive at-a-glance summary of the current state of problematic containers.

The table itself may be structured with several columns, each providing specific information about the flagged containers. The PodName column 508 may list the unique identifiers for each problematic container, allowing for easy reference and/or tracking. The Ready column 510 may indicate the number of instances of the corresponding pod that is in a ready state. The Status column 512 may provide information about the current operational state of the container, which may be helpful in quickly understanding the nature of the issue affecting each pod. The Restart column 514 may show the number of times each container has been restarted, which may be an indicator of stability issues or recurring problems that may warrant further investigation. The Age column 516 may indicate the corresponding age, as further discussed above. This columnar organization of data may offer several advantages in the context of container management. For instance, it may allow administrators to quickly scan for specific types of issues (e.g., readiness problems or frequent restarts) across multiple containers simultaneously. The consistent structure may also facilitate the development of pattern recognition skills among administrators, potentially enabling them to more quickly identify unusual or concerning trends in container behavior. Moreover, this format may lend itself well to sorting or filtering operations, which may further enhance the ability of users to isolate and/or address specific categories of container issues efficiently.

Rows 518-526 may represent individual problematic containers, identified as PODNAME 1 through PODNAME 5. In this example, all of the listed pods may be showing signs of potential issues. The Ready column for each pod may indicate a state of “0/#”, where “#” may represent the total number of instances corresponding to that podname. This may suggest that none of the instances are currently in a ready state, which may be a clear indicator of a problem that may require attention. The Status column for all pods may show “ContainerStatusUnknown”, which may indicate that the container orchestration system is unable to determine the current state of these containers. This unknown status may be a red flag that could prompt administrators to investigate further, as it may suggest communication issues, system errors, or other problems that may be preventing the proper monitoring and/or management of these containers. The consistency of the issues across multiple pods may also be noteworthy, as it may indicate a systemic problem affecting a particular subset of containers or a specific region of the infrastructure. This type of pattern may be more easily discernible in the tabular format presented in FIG. 5, potentially allowing administrators to more quickly identify and/or address widespread issues that may be impacting multiple containers simultaneously. At the bottom of the figure, lines 528-530 may provide additional metadata or log information related to the execution of the wrapper application.

In some examples, the method may further comprise formatting the filtered output into a tabular form to enhance readability for the user. This formatting technique may be applied to the output data to create a structured and easily digestible presentation of container status information, as illustrated in FIG. 5. The tabular format may include columns for various attributes such as PodName 510, Ready status 512, operational Status 514, and/or Restart count 516. This structured presentation may allow users to quickly scan and compare information across multiple containers or pods. However, the concept of formatting for enhanced readability may extend far beyond simple tabular layouts. The filtered output may be presented in various visual formats, such as hierarchical tree structures, heat maps, or interactive dashboards. These alternative formats may be particularly helpful for visualizing complex relationships or patterns within large datasets. In some implementations, the formatting may be dynamic, allowing users to toggle between different views or levels of detail based on their current focus or the specific analysis they are performing. The formatting process may also include color-coding or other visual cues to highlight information or anomalies, making it easier for users to identify potential issues at a glance. For instance, containers with problematic statuses may be highlighted in red, while those operating normally may be displayed in green. Advanced formatting techniques may incorporate data visualization libraries or charting tools to generate graphical representations of container health trends over time. This may include line graphs showing restart frequencies, pie charts illustrating the distribution of container statuses across a cluster, and/or bar charts comparing resource utilization across different pods or namespaces. In some scenarios, the formatting may be customizable, allowing users to define their own templates or layouts based on their specific monitoring priorities or organizational standards. The formatting process may also include the generation of summary statistics or aggregated views, such as those shown in rows 528-530, providing users with high-level insights alongside detailed container information. Furthermore, the formatting may be designed to be responsive, adapting to different display sizes or device types to ensure optimal readability whether viewed on a large monitoring dashboard or a mobile device. In more sophisticated implementations, the formatting may incorporate interactive elements, allowing users to drill down into specific details, apply filters, or trigger actions directly from the formatted output. This interactivity may significantly enhance the usability of the output, enabling more efficient troubleshooting and decision-making processes.

In some examples, the method may further comprise storing the filtered output in a log file for subsequent analysis. This storage technique may extend beyond simple file-based logging to encompass a wide range of data persistence and analysis strategies. The filtered output, which may include the tabular data shown in FIG. 5 with columns such as PodName 510, Ready status 512, operational Status 514, and/or Restart count 516, may be stored in various formats and/or systems to facilitate different types of subsequent analysis. For instance, the data may be persisted in structured log files, potentially using formats like JSON or YAML to maintain the hierarchical relationships between different data points. These structured logs may be easily parsed and/or analyzed by log analysis tools, enabling efficient searching, filtering, and/or pattern recognition across historical data. Alternatively, the filtered output may be stored in time-series databases, which may be particularly well-suited for tracking and/or analyzing container status changes over time. This approach may allow for sophisticated trend analysis, anomaly detection, and/or predictive modeling based on historical container behavior. In some implementations, the storage mechanism may involve distributed data stores, potentially leveraging technologies like Apache Hadoop or Elasticsearch to enable scalable storage and/or analysis of large volumes of container status data across multiple nodes or clusters. The storage process may also incorporate data compression techniques to minimize storage requirements while maintaining data integrity and/or accessibility. Furthermore, the storage mechanism may include automatic rotation and/or archiving of log files to manage storage consumption and/or maintain system performance. In more advanced scenarios, the storage process may involve real-time streaming of filtered output to data processing pipelines, enabling immediate analysis and/or alerting based on container status changes. This real-time processing may be combined with batch storage for long-term analysis, providing both immediate insights and/or historical context. The storage mechanism may also include metadata tagging or indexing to facilitate rapid retrieval of specific subsets of data for targeted analysis. In some implementations, the storage process may incorporate data anonymization or encryption techniques to ensure compliance with data protection regulations or security policies. Additionally, the storage mechanism may support versioning or change tracking, allowing administrators to review the evolution of container statuses over time and/or correlate changes with specific events or actions in the container environment.

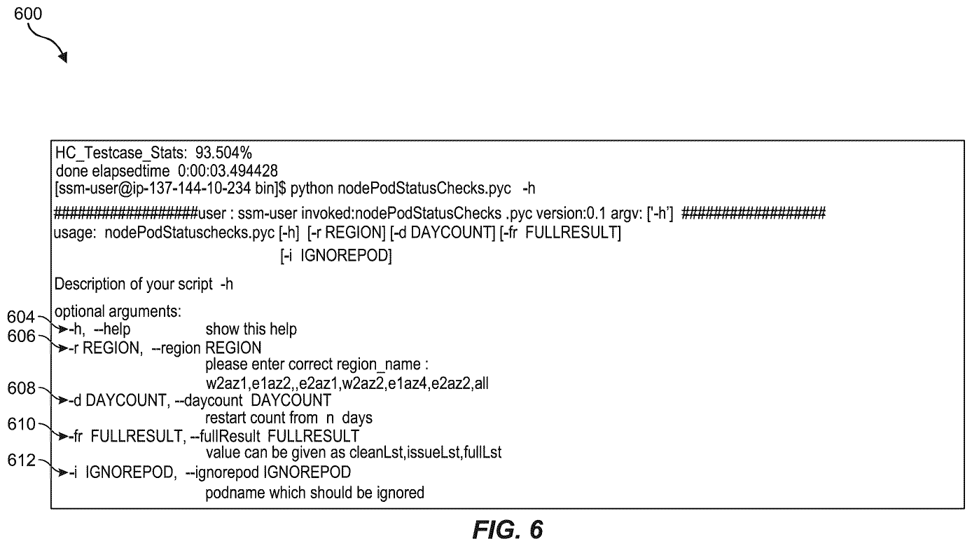

FIG. 6 shows an example of a command-line interface 600 that may be used to interact with a wrapper application in a distributed container management environment. The figure illustrates various optional parameters that may be specified by a user to customize the filtering and/or output of container status information. This type of interface may provide flexibility in how the wrapper application processes and/or presents container status data, potentially allowing administrators to tailor the output to their specific preferences or to focus on particular aspects of the container ecosystem. The command-line interface may offer a powerful and/or flexible tool for interacting with the wrapper application, potentially enabling users to quickly and/or efficiently retrieve the specific information they seek about their container environment. This flexibility may be especially helpful in dynamic or complex container ecosystems where the ability to rapidly adapt monitoring and/or analysis techniques may be beneficial for maintaining system health and/or performance. Additionally, the command-line interface may lend itself well to automation and/or integration with other tools or scripts, potentially enabling more sophisticated monitoring and/or management workflows that may enhance the overall efficiency of container administration tasks.

The −h parameter 604 may be used to display the help information, providing users with a summary of available options and/or their usage. This parameter may be particularly helpful for new users or for those who may seek to refresh their memory on the tool's capabilities. The inclusion of a help option may also facilitate the onboarding of new team members or the sharing of the tool across different groups within an organization, as it may provide a self-contained reference for the wrapper application's functionality. The help output generated by this parameter may serve as a quick reference guide, potentially reducing the need for users to consult external documentation and/or speeding up the process of executing custom queries or analyses. In some scenarios, the help information may also include examples of common usage patterns or best practices, which may further enhance the usability of the wrapper application and/or help users more quickly leverage its full capabilities. The −h parameter may thus play a key role in making the wrapper application more accessible and/or user-friendly, potentially contributing to its adoption and/or effective use within an organization's container management practices.

The −r REGION parameter 606 may allow users to specify a particular region or availability zone for which they seek to retrieve container status information. This option may be helpful in scenarios where administrators may desire to focus their analysis on a specific part of their infrastructure, potentially due to known issues in that region or as part of a routine health check process. The ability to filter by region may also be valuable in large-scale, geographically distributed deployments where different regions may have distinct operational characteristics or requirements. In some examples, the region parameter may be used in conjunction with other filtering options to create highly targeted queries, potentially enabling administrators to quickly isolate and/or address issues that may be specific to certain parts of their container infrastructure. The flexibility offered by this parameter may be particularly beneficial in scenarios where different regions may have varying performance profiles, resource allocations, or service level agreements, allowing administrators to tailor their monitoring and/or management strategies accordingly.

The −d DAYCOUNT parameter 608 may enable users to specify a time period for which to consider container restarts. This parameter may be useful for identifying containers that have experienced stability issues over a particular timeframe, potentially helping administrators to distinguish between transient problems and/or more persistent issues that may require closer attention. The flexibility to adjust the time window for restart analysis may allow for both short-term troubleshooting and/or longer-term trend analysis, depending on the specific needs of the organization. In some scenarios, administrators may use this parameter to correlate container restart patterns with other events or changes in the infrastructure, such as software updates, configuration changes, or variations in workload. The ability to customize the time range for restart analysis may also be helpful in generating reports or metrics that align with specific operational or business cycles, potentially facilitating more meaningful insights into the container environment's performance and/or stability over time.

The −fr FULLRESULT parameter 610 may offer users the ability to customize the type of output generated by the wrapper application. Options such as “cleanlst,” “issuelst,” or “fulllst” may provide different levels of detail or focus in the results, potentially allowing administrators to tailor the output to their current task or level of analysis. This parameter may be particularly helpful in scenarios where users may seek to balance the comprehensiveness of the output with the need for quick, focused insights into the container ecosystem's health. The ability to choose between different output formats may enable administrators to efficiently switch between high-level overviews and/or detailed analyses, depending on their current needs or the specific context of their investigation. In some examples, the different output options may be designed to highlight specific aspects of container health or performance, potentially making it easier for users to quickly identify and/or prioritize issues that may require attention. The flexibility provided by this parameter may contribute to a more efficient and/or effective container management process, allowing administrators to adapt their approach based on the specific requirements of each situation or analysis task.

The −i IGNOREPOD parameter 612 may allow users to specify certain pods that should be excluded from the analysis. This feature may be helpful in scenarios where certain containers may be known to have specific behaviors or statuses that are not indicative of problems, or in cases where administrators may seek to focus their attention on a subset of the container ecosystem. The ability to ignore specific pods may help reduce noise in the output and/or allow for more targeted analysis of the remaining containers. In some examples, this parameter may be used to exclude test or development containers from production monitoring, or to temporarily remove containers that are undergoing maintenance or planned updates from health checks. The flexibility to selectively include or exclude specific pods from the analysis may enable administrators to create more refined and/or relevant views of their container ecosystem, potentially leading to more accurate assessments of system health and/or more efficient troubleshooting processes. Additionally, the ability to ignore certain pods may be valuable in scenarios where different teams or departments within an organization may have varying levels of responsibility or interest in specific subsets of the container infrastructure, allowing for customized monitoring and/or reporting based on specific operational roles or requirements.

In some examples, the method may further comprise executing the container orchestration command with at least one additional parameter that comprises one or more of: a help request, a region specification, a time period specification for a restart criterion, a result type specification, or a container exclusion specification. This execution technique may involve a wide range of parameter configurations and command customizations to tailor the container status retrieval process to specific operational needs. As illustrated in FIG. 6, the command-line interface 600 may support various optional parameters, such as the −h parameter 604 for displaying help information, the −r REGION parameter 606 for specifying a particular region or availability zone, the −d DAYCOUNT parameter 608 for defining a time window for restart analysis, the −fr FULLRESULT parameter 610 for customizing the output format, and/or the −i IGNOREPOD parameter 612 for excluding specific containers from the analysis. These parameters may be combined in numerous ways to create highly specialized queries. For instance, an administrator may execute the command with both a region specification and/or a time period specification to focus on recent issues in a particular geographical area of the infrastructure. The help request parameter may be expanded to include context-sensitive help, potentially offering dynamic suggestions based on the current state of the container environment or the user's recent command history. Region specifications may be extended to support complex topology definitions, allowing for the selection of multiple regions, specific node groups, or custom-defined subsets of the infrastructure. The time period specification for the restart criterion may be enhanced to support various time units and/or relative time expressions, such as “last 24 hours” or “since last deployment,” providing flexible ways to analyze container stability. Result type specifications may be expanded to include options for different levels of detail, custom field selections, or output formats optimized for specific analysis tools or dashboards. Container exclusion specifications may be augmented with pattern matching or label-based filtering, allowing for more sophisticated exclusion rules. Additionally, the command execution may support environment variables or configuration files for storing default parameter values, reducing the need for repetitive command-line input. The parameter handling may also include input validation and/or intelligent defaults to minimize errors and/or streamline the command execution process. In more advanced implementations, the command may support dynamic parameter generation based on the current state of the container environment, potentially suggesting relevant filters or analysis criteria based on detected anomalies or recent changes in the infrastructure.

In some examples, the specified time period for the restart criterion may be configurable by the user. This configurability may extend far beyond simple numerical input, encompassing a wide range of time specification techniques and/or customization options. As illustrated in FIG. 6, the −d DAYCOUNT parameter 608 may allow users to specify a time period for considering container restarts. However, this concept may be expanded to include more sophisticated time period configurations. Users may be provided with options to specify time periods using various units, such as hours, minutes, seconds, and/or even custom time intervals. The time period specification may also support relative time expressions, such as “since last deployment,” “within the last operational cycle,” and/or “during peak hours.” These relative time specifications may be particularly helpful in environments with dynamic operational patterns and/or varying deployment frequencies. The configurability may extend to include support for complex time ranges, potentially allowing users to define multiple time windows or exclude specific time periods from the analysis. For instance, users may specify restart criteria that only consider weekday operations and/or ignore scheduled maintenance windows. The time period configuration may also incorporate timezone awareness, enabling accurate restart analysis across geographically distributed container environments. Advanced implementations may support the use of cron-like expressions for defining recurring time windows, providing users with fine-grained control over when restart events are considered significant. The configuration interface may include graphical tools for time period selection, such as calendars and/or interactive timelines, making it more intuitive for users to define complex time criteria. Furthermore, the time period configuration may be integrated with historical data analysis tools, allowing users to dynamically adjust the time window based on observed patterns or anomalies in container behavior. The system may also offer preset time period templates based on common operational scenarios or best practices, which users may select and/or customize as needed. In some implementations, the time period configuration may support automated adjustments based on machine learning algorithms that analyze historical restart patterns and/or suggest optimal time windows for different types of containers and/or services.

In some examples, the wrapper application may increase a speed with which faulty nodes are identified across multiple availability zones in the cluster. This speed improvement may be achieved through various techniques and/or optimizations that leverage the capabilities of distributed container management environments. The wrapper application may employ parallel processing algorithms to simultaneously analyze container status data from multiple availability zones, potentially utilizing the region specification functionality illustrated by the −r REGION parameter 606 in FIG. 6. This parallel processing may be implemented using multi-threading, distributed computing frameworks, and/or cloud-native technologies that enable efficient data processing across geographically dispersed infrastructure. The wrapper application may also implement intelligent caching mechanisms to store and/or quickly retrieve frequently accessed status information, reducing the need for repeated queries to the container orchestration system. These caches may be strategically distributed across availability zones to minimize latency and/or improve resilience. Additionally, the application may utilize predictive pre-fetching algorithms to anticipate which nodes or containers may require inspection based on historical patterns and/or current system state, potentially pre-loading relevant data to speed up subsequent analyses. The wrapper may also employ adaptive sampling techniques, dynamically adjusting the frequency and/or depth of status checks based on the observed health of different parts of the cluster. This approach may allow for more frequent and/or thorough checks of potentially problematic areas while reducing overhead in stable regions.

Furthermore, the application may implement stream processing techniques to analyze container status data in real-time as it is generated, enabling immediate detection of faulty nodes without waiting for batch processing cycles. The wrapper may also leverage machine learning algorithms to improve its fault detection capabilities over time, potentially identifying subtle indicators of node issues that may not be apparent through traditional rule-based checks. These algorithms may be trained on historical data from across multiple availability zones, enabling them to recognize patterns that may be indicative of emerging problems across diverse infrastructure configurations. The speed of fault identification may also be improved through optimized data structures and/or indexing techniques that allow for rapid searching and/or filtering of large volumes of container status information. In scenarios where network latency between availability zones may impact performance, the wrapper application may implement edge computing techniques, deploying analysis components closer to the data sources to reduce data transfer times and/or improve responsiveness.

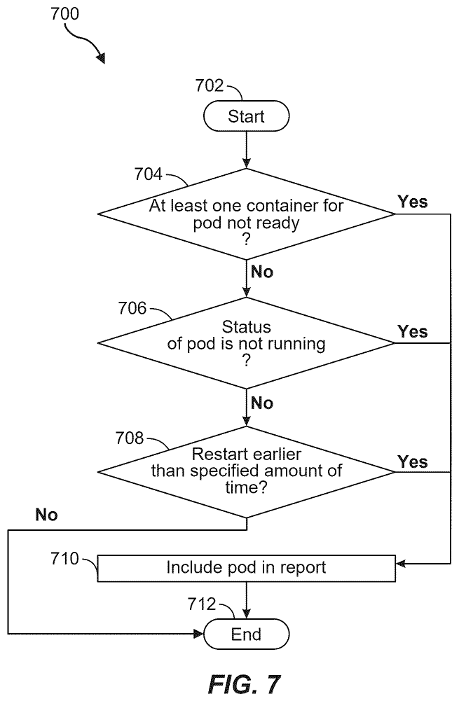

FIG. 7 shows an example flow diagram 700 that may illustrate a process for identifying containers that may benefit from attention in a distributed container management environment. This diagram may represent one possible implementation of the filtering logic that may be employed by a wrapper application to analyze container status information and/or generate reports on potentially problematic containers. The flow diagram 700 may depict a series of decision points and/or actions that may be taken to determine whether a given container should be included in a report of issues or anomalies. This type of logic may be helpful in streamlining the container monitoring process and/or focusing attention on containers that may be experiencing issues or deviating from expected operational parameters. The technique illustrated in this flow diagram may offer a systematic method for evaluating the health and/or status of containers within a cluster, potentially enabling more efficient identification of problematic instances that may require further investigation or intervention. By breaking down the evaluation process into distinct steps, this technique may allow for a more granular and/or thorough assessment of container status, which may be particularly valuable in large-scale deployments where manual inspection of each container may be impractical or time-consuming.

The process may begin at the start step 702, which may represent the initiation of the container status checking routine. This starting point may be triggered by various events, such as a scheduled job, a manual request from an administrator, or in response to certain system events or thresholds being met. From this starting point, the process may proceed through a series of decision points, each of which may evaluate a different aspect of the container's status or behavior. The order in which these checks are performed may be arbitrary and/or may be customized based on specific operational preferences or priorities. In some implementations, the sequence of checks may be dynamically adjusted based on factors such as historical data, system load, or the specific characteristics of the container being evaluated. The flexibility in the order of checks may allow administrators to prioritize certain types of issues or to optimize the evaluation process based on the unique characteristics of their container environment. For example, in scenarios where restart-related issues are more common or more helpful, the restart check may be performed first to quickly identify containers experiencing frequent restarts. Alternatively, in environments where readiness states are particularly important for service availability, the readiness check may be given priority in the evaluation sequence.

The first decision point 704 may check whether at least one container for the pod is not ready. This check may assess the readiness state of the containers within a pod, which may be an indicator of whether the pod is fully operational and/or capable of handling requests or workloads. If this check results in a “yes” (i.e., at least one container is not ready), the process may proceed directly to step 710 to include the pod in the report. If the result is “no” (i.e., all containers are ready), the process may continue to the next decision point. This readiness check may be particularly helpful in identifying pods that may be experiencing startup issues, configuration problems, or other factors that may prevent them from becoming fully operational. The concept of container readiness may be complex and/or multifaceted, potentially involving various health checks, dependency verifications, or initialization processes. By isolating this check as a distinct step in the evaluation process, the technique may allow for a more nuanced assessment of container health, potentially catching issues that may not be immediately apparent from other status indicators.

The second decision point 706 may evaluate whether the status of the pod is not running. This check may look at the overall operational state of the pod, which may provide insights into whether the pod is actively processing workloads or if it has entered an inactive or error state. Similar to the previous check, a “yes” result (i.e., the pod is not running) may lead directly to step 710 for inclusion in the report, while a “no” result may allow the process to continue to the next decision point. This status check may be valuable for identifying pods that may have crashed, been stopped, or entered an unexpected state that may require investigation or intervention. The “running” status may encompass a range of operational states, and this check may help identify pods that have deviated from their expected active state. This may be particularly important in maintaining the overall health and/or performance of the container ecosystem, as non-running pods may indicate underlying issues with the application, infrastructure, or orchestration processes.

The third decision point 708 may determine whether a restart has occurred earlier than a specified amount of time. This check may be used to identify pods that may be experiencing stability issues or frequent crashes, which may be indicated by restarts occurring more frequently than expected. As with the previous checks, a “yes” result may lead to step 710 and inclusion in the report, while a “no” result may allow the process to bypass step 710 and proceed directly to the end step 712. This restart frequency check may be helpful in identifying pods that may be experiencing recurring issues or may be part of a problematic deployment that may require further investigation or optimization. The time threshold for this check may be configurable, allowing administrators to adjust the sensitivity of the restart detection based on their specific operational requirements or the expected behavior of different types of containers. This flexibility may enable the technique to adapt to various use cases and/or deployment scenarios, potentially improving its effectiveness across diverse container environments.

In some examples, the third-party cloud computing platform may comprise a publicly available cloud computing service. This concept of utilizing publicly available cloud computing services for container orchestration and management may encompass a wide range of implementation scenarios and service models. The publicly available cloud computing service may offer various levels of abstraction and control, ranging from Infrastructure as a Service (IaaS) to Platform as a Service (PaaS) and even Container as a Service (CaaS) offerings. These services may provide the underlying infrastructure and tools necessary for deploying, scaling, and managing containerized applications, as represented by the container health check process illustrated in FIG. 7. The public cloud platform may offer managed Kubernetes services, where the cloud provider handles the complexities of cluster management, allowing users to focus on container deployment and application management. In such scenarios, the decision points in FIG. 7, such as checking for container readiness 704, running status 706, and restart frequency 708, may be implemented using cloud-native tools and APIs provided by the public cloud platform. Alternatively, the public cloud may serve as a foundation for self-managed container orchestration systems, where users have more control over the underlying infrastructure and orchestration tools. The publicly available cloud computing service may also offer hybrid and multi-cloud capabilities, allowing organizations to extend their container environments across multiple public cloud providers and/or on-premises infrastructure. This flexibility may enable more robust and distributed container deployments, potentially improving resilience and performance. The public cloud platform may provide additional services that complement container orchestration, such as managed databases, load balancers, and monitoring tools, which may be integrated into the container health check process. These services may enhance the overall manageability and observability of containerized applications. Furthermore, the public cloud may offer serverless container execution environments, where the underlying infrastructure management is entirely abstracted away, potentially simplifying the deployment and scaling of containerized applications. In such scenarios, the health check process illustrated in FIG. 7 may be adapted to work with the specific constraints and capabilities of serverless container platforms. The use of publicly available cloud computing services may also facilitate easier integration with third-party tools and services for container management, monitoring, and analytics, potentially enhancing the capabilities of the wrapper application in identifying and addressing container health issues.

In some examples, the wrapper application may comprise a script that extends functionality of the container orchestration command. This script-based extension technique may encompass a wide range of implementation approaches and functional enhancements to the underlying container orchestration system. The script may be developed using various scripting languages, such as Python, Bash, Ruby, or PowerShell, each offering different capabilities and integration possibilities with the container orchestration platform. The script may interact with the container orchestration command through various interfaces, including command-line execution, API calls, and/or direct integration with the orchestration system's libraries. As illustrated in FIG. 7, the script may implement a series of checks and decision points, such as verifying container readiness 704, assessing running status 706, and/or evaluating restart frequency 708. These checks may be customized and/or extended based on specific operational requirements and/or the unique characteristics of the container environment. The script may incorporate advanced error handling and logging mechanisms to provide detailed information about the status checks performed and/or any issues encountered during execution. Additionally, the script may implement retry logic and/or graceful degradation strategies to handle temporary failures or inconsistencies in the container orchestration system's responses. The wrapper script may also include functionality to aggregate and/or correlate data from multiple sources, potentially combining information from the container orchestration command with metrics from monitoring systems, log aggregators, and/or other infrastructure components to provide a more comprehensive view of container health. The script may leverage environment variables, configuration files, and/or command-line arguments to allow for flexible customization of its behavior without modifying the core code. This configurability may enable the script to adapt to different deployment scenarios and/or operational preferences. Furthermore, the script may implement caching mechanisms to store and/or reuse frequently accessed data, potentially improving performance in large-scale environments. The wrapper script may also include self-updating capabilities, allowing it to automatically retrieve and/or apply updates to its logic or configuration based on predefined triggers or schedules. This may help ensure that the extended functionality remains current and/or aligned with evolving best practices in container management.

In some examples, the distributed container management environment may comprise a Kubernetes-compatible system. This Kubernetes compatibility may extend to a wide range of container orchestration platforms and implementations that share similar architectural principles and/or operational paradigms with Kubernetes. The environment may include systems that adopt Kubernetes-like concepts such as pods, deployments, services, and namespaces, even if they use different terminology or specific implementation details. These Kubernetes-compatible systems may implement similar health check mechanisms as illustrated in FIG. 7, where container readiness 704, running status 706, and restart frequency 708 are evaluated to determine overall health. The compatibility may extend to supporting Kubernetes-style declarative configuration, allowing users to define desired states for their applications and relying on the system to reconcile the actual state with the desired state. Such systems may offer APIs and command-line interfaces that closely mirror or extend those found in Kubernetes, facilitating easier adoption and integration with existing tools and workflows. The Kubernetes-compatible environment may include distributions like OpenShift, Rancher, or Google Kubernetes Engine (GKE), each potentially offering additional features or optimizations on top of the core Kubernetes functionality. These systems may extend the basic health check process shown in FIG. 7 with platform-specific metrics or checks, while maintaining compatibility with standard Kubernetes resources and concepts. The environment may also encompass lightweight Kubernetes distributions designed for edge computing or IoT scenarios, such as K3s or MicroK8s, which may implement simplified versions of the health check process while retaining core Kubernetes compatibility. Furthermore, the Kubernetes-compatible system may include abstraction layers or adapters that allow non-Kubernetes container orchestration platforms to present a Kubernetes-compatible interface, enabling the use of Kubernetes tools and workflows in diverse container environments. This compatibility may extend to supporting Kubernetes-style monitoring and logging integrations, allowing the health check process to leverage a wide ecosystem of observability tools and practices. The Kubernetes-compatible environment may also support extensions and custom resource definitions (CRDs) that allow for the implementation of specialized health checks or management practices tailored to specific application requirements, while maintaining overall compatibility with the Kubernetes paradigm.

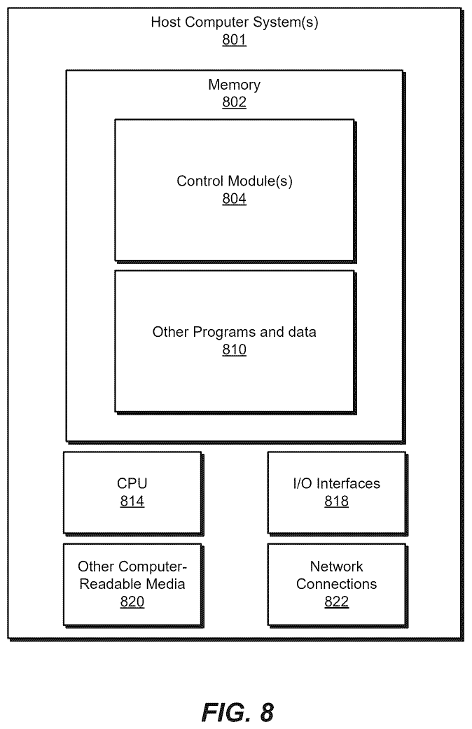

FIG. 8 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 8 illustrates an example of underlying hardware on which such software and functionality may be hosted and/or implemented.

In particular, shown is example host computer system(s) 801. For example, such computer system(s) 801 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 801 may include memory 802, one or more central processing units (CPUs) 814, I/O interfaces 818, other computer-readable media 820, and network connections 822.

Memory 802 may include one or more various types of non-volatile and/or volatile storage technologies. Examples of memory 802 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 802 may be utilized to store information, including computer-readable instructions that are utilized by CPU 814 to perform actions, including those of embodiments described herein.

Memory 802 may have stored thereon control module(s) 804. The control module(s) 804 may be configured to implement and/or perform some or all of the functions of the systems or components described herein. Memory 802 may also store other programs and data 810, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 822 are configured to communicate with other computing devices to facilitate the functionality described herein. In various embodiments, the network connections 822 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 818 may include a video interface, other data input or output interfaces, or the like. Other computer-readable media 820 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a wrapper application, status information retrieved by a container orchestration command executed in a distributed container management environment that interfaces with a third-party cloud computing platform, the status information comprising data for a plurality of containers in a cluster that is part of the distributed container management environment and that is allocated to a subscriber of the third-party cloud computing platform;
applying, by the wrapper application to the received status information, identification criteria comprising at least two of: (i) a non-ready state, (ii) a non-running status, or (iii) a restart within a specified time period to identify containers that satisfy the identification criteria such that the wrapper application checks for whether any of the at least two criteria applies to each respective container in the cluster; and
generating, by the wrapper application, a filtered output that comprises status details for the identified containers while filtering out at least one container that does not meet the identification criteria such that the filtered output presents a subset of the received status information to reduce a burden on a user of identifying the filtered output from within the received status information.

2. The method of claim 1, wherein the identification criteria comprise (i) the non-ready state and (ii) the non-running status.

3. The method of claim 1, wherein the identification criteria comprise (i) the non-ready state and (iii) the restart within the specified time period.

4. The method of claim 1, wherein the identification criteria comprise (ii) the non-running status and (iii) the restart within the specified time period.

5. The method of claim 1, wherein the identification criteria comprise (i) the non-ready state, (ii) the non-running status, and (iii) the restart within the specified time period.

6. The method of claim 1, wherein the third-party cloud computing platform comprises a publicly available cloud computing service.

7. The method of claim 1, further comprising executing the container orchestration command with at least one additional parameter that comprises one or more of: a help request, a region specification, a time period specification for a restart criterion, a result type specification, or a container exclusion specification.

8. The method of claim 1, further comprising formatting the filtered output into a tabular form to enhance readability for the user.

9. The method of claim 1, wherein the wrapper application comprises a script that extends functionality of the container orchestration command.

10. The method of claim 1, wherein the distributed container management environment comprises a Kubernetes-compatible system.

11. The method of claim 1, wherein the container orchestration command comprises a command that retrieves status information for all containers in a specified cluster.

12. The method of claim 1, wherein the container orchestration command comprises kubectl.

13. The method of claim 1, wherein the specified time period is configurable by the user.

14. The method of claim 1, further comprising storing the filtered output in a log file for subsequent analysis.

15. The method of claim 1, wherein the wrapper application processes a volume of container status data such that problematic containers are identified from a search of at least a hundred containers in the cluster.

16. The method of claim 1, wherein the wrapper application increases a speed with which faulty nodes are identified across multiple availability zones in the cluster.

17. A non-transitory computer-readable medium that has instructions stored thereon that, when executed by at least one physical computing processor, cause a computing device to perform operations comprising:
receiving, by a wrapper application, status information retrieved by a container orchestration command executed in a distributed container management environment that interfaces with a third-party cloud computing platform, the status information comprising data for a plurality of containers in a cluster that is part of the distributed container management environment and that is allocated to a subscriber of the third-party cloud computing platform;
applying, by the wrapper application to the received status information, identification criteria comprising at least two of: (i) a non-ready state, (ii) a non-running status, or (iii) a restart within a specified time period to identify containers that satisfy the identification criteria such that the wrapper application checks for whether any of the at least two criteria applies to each respective container in the cluster; and
generating, by the wrapper application, a filtered output that comprises status details for the identified containers while filtering out at least one container that does not meet the identification criteria such that the filtered output presents a subset of the received status information to reduce a burden on a user of identifying the filtered output from within the received status information.

18. The non-transitory computer-readable medium of claim 17, wherein the identification criteria comprise (i) the non-ready state and (ii) the non-running status.

19. A system comprising:
at least one physical computing processor of a computing device; and
a non-transitory computer-readable medium that has instructions stored thereon that, when executed by the at least one physical computing processor, cause the computing device to perform operations comprising:
receiving, by a wrapper application, status information retrieved by a container orchestration command executed in a distributed container management environment that interfaces with a third-party cloud computing platform, the status information comprising data for a plurality of containers in a cluster that is part of the distributed container management environment and that is allocated to a subscriber of the third-party cloud computing platform;
applying, by the wrapper application to the received status information, identification criteria comprising at least two of: (i) a non-ready state, (ii) a non-running status, or (iii) a restart within a specified time period to identify containers that satisfy the identification criteria such that the wrapper application checks for whether any of the at least two criteria applies to each respective container in the cluster; and
generating, by the wrapper application, a filtered output that comprises status details for the identified containers while filtering out at least one container that does not meet the identification criteria such that the filtered output presents a subset of the received status information to reduce a burden on a user of identifying the filtered output from within the received status information.

20. The system of claim 19, wherein the identification criteria comprise (i) the non-ready state and (ii) the non-running status.
